(19) United States
(12) Patent Application Publication
(10) Pub. No.: US 2019/0022556 A1
(43) Pub. Date: Jan. 24, 2019

(54) SYSTEMS AND METHODS FOR ORGANIC COMPOUND STORAGE AND TRANSFER

(71) Applicant: Hamilton Sundstrand Corporation, Charlotte, NC (US)

(72) Inventors: Jonathan Rheaume, West Hartford, CT (US); Haralambos Cordatos, Colchester, CT (US)

(21) Appl. No.: 15/656,925

(22) Filed: Jul. 21, 2017

(51) Int. Cl. B01D 19/00; F17C 11/00; C10L 1/04; B64D 37/32

(52) U.S. Cl. CPC B01D 19/0031; F17C 11/007; B01D 19/0068; C10L 1/04; B64D 37/32; C10L 2290/46; F17C 2227/0157; F17C 2270/0186; C10L 2290/541; C10L 2290/548; F17C 2221/032

(57) ABSTRACT

A method for mitigating gas and vapor absorption into organic compounds includes degassing an organic compound to generate a degassed organic compound that includes an O₂ content less than or equal to 50% of a saturated value of the organic compound. The method includes transferring the degassed organic compound while preventing contamination of the organic compound through gas absorption. The method includes storing the degassed organic compound in a storage receptacle to mitigate gas and vapor absorption. An organic compound storage and transfer system includes an organic compound source. An organic compound from the organic compound source includes an O₂ content less than or equal to 50% of a saturated value of the organic compound. A storage receptacle is in fluid communication with the organic compound source. An inert gas source is in fluid communication with the storage receptacle to purge the storage receptacle of other gasses and vapors.

### BACKGROUND OF THE INVENTION

### 1. Field of the Invention

The present disclosure relates to storage systems, and more particularly to storage systems for organic compounds, such as fuel storage systems for stabilized fuel.

### 2. Description of Related Art

Fuel can be stabilized off-board of air vehicles and then transferred to fuel tanks on-board of the air vehicles. This tends to make the stabilized fuel susceptible to oxygen and other gases and vapors re-dissolving into the fuel during fueling or in storage on- or off-board the air vehicle. Oxygen and other gases and vapors dissolved in the fuel can reduce the effectiveness of the fuel in some instances, for example, when fuel is being used as a heat sink. Dissolved oxygen in fuel participates in auto-oxidation reactions that can lead to the formation of carbonaceous solids that can adversely affect the performance of fuel systems.

The conventional techniques for providing stabilized fuel have been considered satisfactory for their intended purpose, however, the fuel stabilization units have typically been too bulky for aerospace applications. As a result, there is an ever present need for improved storage and transferring of stabilized fuel. This disclosure provides a solution for this need.

### SUMMARY OF THE INVENTION

A method for mitigating gas and vapor absorption into organic compounds includes degassing an organic compound to generate a degassed organic compound that includes an O₂ content less than or equal to 50% of a saturated value of the organic compound. The method includes transferring the degas sed organic compound while preventing contamination of the organic compound through gas absorption. The method includes storing the degassed organic compound in a storage receptacle to mitigate gas and vapor absorption.

In accordance with some embodiments, degassing the organic compound includes degassing by using a membrane. The method can include supplying inert gas to the storage receptacle, wherein transferring the degas sed organic compound can include pumping the degassed organic compound into the storage receptacle supplied with the inert gas. Supplying inert gas to the storage receptacle can include supplying the inert gas with an on-board inert gas generating system (IGGS). The IGGS can receive compressed air from a load compressor powered by at least one of an auxiliary power unit (APU) or ground power. Supplying inert gas to the storage receptacle can include supplying enough inert gas to generate an inert atmosphere with less than 1% O₂ by volume.

In accordance with some embodiments, the method includes continuing to supply the inert gas to the storage receptacle after filling to prevent contamination after filling. The method can include pre-purging the storage receptacle by supplying inert gas to the storage receptacle before transferring the degassed organic compound.

It is contemplated that the storage receptacle can be an off-board bladder tank, a hermetically sealed off-board fuel tank, a vented off-board fuel tank, an on-board bladder tank, a hermetically sealed on-board fuel tank, and/or a vented on-board fuel tank. The storage receptacle can be a tank, storage vessel, product package, container, or bladder for at least one of a comestible product, an essential oil, or an infused oil.

In accordance with another aspect, an organic compound storage and transfer system includes an organic compound source. An organic compound from the organic compound source includes an O₂ content less than or equal to 50% of a saturated value of the organic compound. A storage receptacle is in fluid communication with the organic compound source. An inert gas source is in fluid communication with the storage receptacle to purge the storage receptacle of other gasses and vapors.

It is contemplated that an inert gas source can be an on-board inert gas generating system (IGGS). The system can include a load compressor in fluid communication with the IGGS to provide compressed air to the IGGS, wherein the load compressor is powered by at least one of an APU or ground power. The storage receptacle can be an off-board storage receptacle, an on-board storage receptacle, a vented storage receptacle, and/or a hermetically sealed storage receptacle. The storage receptacle can be a bladder. The bladder can comprise an elastomeric material. The inert gas source can comprise primarily N₂. The inert gas source can be a catalytic oxidation system, and/or an electrochemical gas separation system. It is contemplated that the inert gas source can be in fluid communication with an inlet at a bottom of the storage receptacle to provide an inert gas thereto.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of a system constructed in accordance with the present disclosure, showing a system for the generation, storage, and transfer of de-gassed organic compounds.

### DETAILED DESCRIPTION OF THE PREFERRED EMBODIMENTS

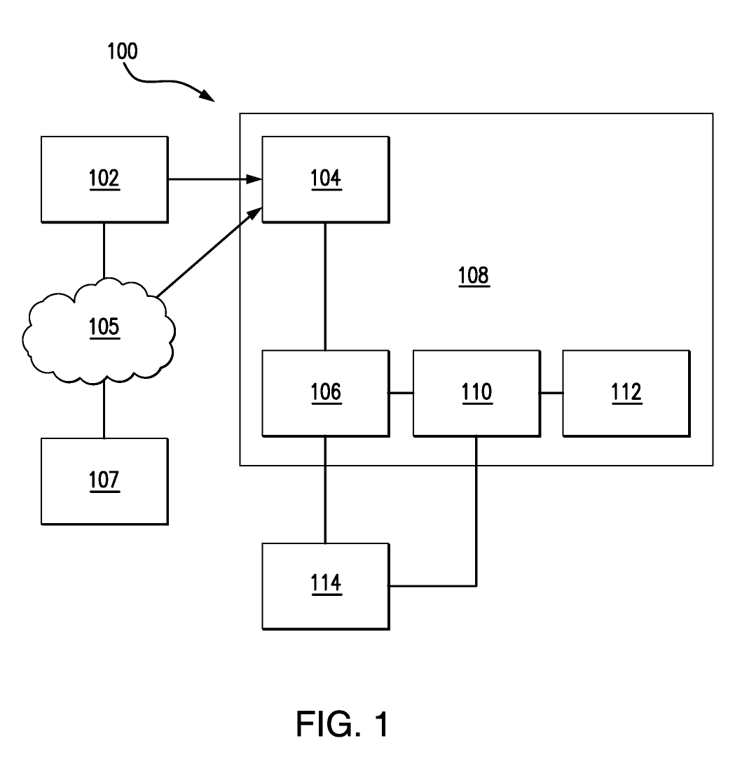

Reference will now be made to the drawings wherein like reference numerals identify similar structural features or aspects of the subject disclosure. For purposes of explanation and illustration, and not limitation, a schematic depiction of an exemplary embodiment of an organic compound storage and transfer system in accordance with the disclosure is shown in FIG. 1 and is designated generally by reference character 100. The systems and methods described herein can be used to store organic compounds, such as stabilized fuel, so that gasses such as oxygen and other vapors in the ullage do not re-dissolve into fuel. De-gassing fuel and other organic compounds and keeping them gas-free is important for several purposes. These include keeping fuel stabilized to be used as a heat sink, prevent water ingress, and to obviate vapor lock. Those skilled in the art will readily appreciate that removing oxygen from fuel by selected methods can also remove dissolved water and other gases, and the same storage methods are applicable.

As shown in FIG. 1, an organic compound storage, and transfer system 100 includes an organic compound source 102. A degassed organic compound from organic compound source 102 includes an O₂ content less than or equal to 50% of the saturated value of the organic compound. The organic compound, for example, can be stabilized fuel. In accordance with some embodiments, organic compound source 102 includes an O₂ content less than 30% of the saturated value of the organic compound. For example, for stabilized fuel, the O₂ content can be equivalent to 35 ppm by weight (ppmw) O₂ at room temperature, 20 ppmw O₂ at room temperature, or less than 10 ppmw, in accordance with some embodiments. Kerosene-based fuels, such as jet A and jet A−1, have a saturated value, e.g. its O₂ content in an unstabilized state, of approximately 70 ppm O₂ by weight at room temperature. A storage receptacle 104 is in fluid communication with organic compound source 102. Storage receptacle 104 is shown on-board, e.g. on-board an aircraft 108. An off-board storage receptacle 105 can also be used. Off-board storage receptacle 105 can be in fluid communication with storage receptacle 104 or it can be independent thereof. It is contemplated that off-board storage receptacle can be on a land-vehicle such as a truck or trailer, or a storage facility. Off-board storage receptacle 105 is shown as a bladder made from an elastomeric material. It is contemplated that receptacle 105 can be in fluid communication with storage receptacle 104 or it can be independent thereof. Those skilled in the art will readily appreciate that degassing an organic compound to generate a degassed organic compound can include removing some gases such as O₂, for example by sparging with nitrogen, or can include removing all gasses, including O₂ and N₂, for example by vacuum based methods with membranes.

An inert gas source 106 is in fluid communication with storage receptacle 104 to purge storage receptacle 104 of other gasses and vapors. Inert gas source 106 can pre-purge receptacle 104, continuously purge receptacle 104 during filling, and continuously purge receptacle 104 after filling to prevent contamination, e.g. contamination via vent in a vented fuel tank, typically found on commercial aircraft. It is also contemplated that some oxygen that may be present in the inert gas may infuse into the organic compound, e.g. fuel, during transfer and storage. The oxygen transfer from the inert gas to organic compound can be mitigated, for example, by avoiding droplet formation of liquid hydrocarbon fuel (don't spray, but rather fill below the fuel/air interface to minimize surface area of liquid organic compound exposed to inert gas). Inert gas source 106 can be an on-board inert gas generating system (IGGS 106). A load compressor 110 is in fluid communication with IGGS 106 to provide compressed air to IGGS 106. Load compressor 110 and IGGS 106 are powered by at least one of an APU 112 on aircraft 108 or ground power 114. Those skilled in the art will recognize that traditional inerting systems on aircraft tend to only be operational while propulsion engines are on, while embodiments of the present invention can be used while the propulsion engines are off, e.g. during re-fueling of the aircraft.

Those skilled in the art will readily appreciate that inert gas source 106 can be a variety of modules or systems. For example, air separation modules, technology that uses selectively permeable membranes and compressed air to separate oxygen from air and thus generate inert gas, can be used. Catalytic oxidation units that create an inert gas by combusting some fuel to deplete the oxygen content in air can be used. The resulting inert gas must be dried prior to introduction into a fuel tank. In some embodiments, an electrochemical gas separation unit, for example, that described in U.S. Pat. No. 9,623,981, which is incorporated by reference in its entirety, can be used. It is also contemplated that a pressure-swing adsorption system can be used.

With continued reference to FIG. 1, off-board storage receptacle 105 optionally has an inert gas source 107 that is also off-board. Storage receptacles 104 and 105 can be vented storage receptacles, like a vented fuel tank described above, or hermetically sealed, like fuel tanks found on military aircraft. Those skilled in the art will readily appreciate that storage receptacle 104 can be a bladder style such as a fuel cell bladder, like receptacle 105 and receptacle 105 can be a tank style receptacle like receptacle 104. It is also contemplated that storage receptacle 104 and receptacle 105 can be variable volume bladders and/or other variable volume storage style tanks. It is contemplated that inert gas source 106 can comprise primarily N₂. It is contemplated that inert gas source 106 can comprise primarily N₂. Additionally, storage receptacles 104 and 105 can be a tanks, storage vessels (such as bottles), and/or bladders for a variety of organic products, such as plant-based oils, including comestible products (e.g. olive oil), essential oils (e.g. tea tree oil), and infused oils (e.g. calendula oil), other types of fuels such as kerosene-based jet fuel, diesel fuel, biodiesel fuel, and the like, and petroleum-based products such as those found in lotions, cosmetics, and the like. System 100 can be used to process and/or store the variety of organic products listed above.

A method for mitigating gas and vapor absorption into organic compounds includes degassing an organic compound to generate a degassed organic compound that includes an O₂ content less than or equal to 50% of the saturated value of the organic compound. For example, for kerosene-based fuel, this can be less than 20 ppmw O₂, or less than 10 ppmw O₂ in accordance with some embodiments. The O₂ content will vary depending on the saturated value of the compound, the saturated value of the compound can vary based on temperature of the compound. The method includes degassing the organic compound by using a membrane. This and other methods of degassing are described, for example, in U.S. Pat. Nos. 6,315,815, 6,709,492, 7,393,388, and 7,465,336 which are all hereby incorporated by reference in their entirety. In these systems, however, after degassing, the organic compound, e.g. fuel, is transported directly into use.

The method includes transferring the degassed organic compound from an organic compound source, e.g. the organic compound source 102, while preventing contamination of the organic compound through absorption of gaseous species including water vapor. The method includes transferring the degassed organic compound from the organic compound source into storage by pumping the degassed organic compound into a storage receptacle, e.g. storage receptacle 104 or 105, while continuously supplying inert gas to the storage receptacle. This transferring can be, for example, from the organic compound source off-board an aircraft, e.g. aircraft 108, to a receptacle, e.g. storage receptacle 104, on-board the aircraft. The transferring can be from an on-board organic compound source as well. It is also contemplated that the organic compound source can be off-board the aircraft and transferred to a receptacle, e.g. storage receptacle 105, off-board the aircraft. The method includes pre-purging the storage receptacle by supplying inert gas to the storage receptacle before transferring the degassed organic compound.

The inert gas is supplied by using an on-board inert gas generating system, e.g. IGGS 106, or an off-board inert gas source, e.g. inert gas source 107. It is contemplated that the IGGS or other inert gas source generates an atmosphere in the ullage with less than 1% O₂ by volume, or less than 0.5% O₂ in accordance with some embodiments. The IGGS receives compressed air from a load compressor, e.g. load compressor 110. The method includes continuing to supply the inert gas to the storage receptacle after filling to assist in preventing contamination after filling. The amount and/or rate of post-fill inert gas supply will depend on the size and fluid activity in the storage receptacle. For example, certain large, ground-based storage tanks (wherein the liquid is largely stagnant) may require very minimal post-fill inert gas supply, since the diffusion of gases back into the liquid is very slow. It is contemplated that the purging and continuous inert gas supply during filling and after can be provided without propulsion engines of the system, e.g. the aircraft, on, as the load compressor can be powered by an APU, e.g. APU 112, and/or ground power, e.g. ground power supply 114. In accordance with some embodiments, inert gas may be supplied to an inlet at a bottom of the storage receptacle, e.g. storage receptacle 104 or 105. This embodiment would be in scenarios where the inert gas has sufficient pressure to overcome the head of the liquid in the receptacle. It is contemplated that this embodiment would afford an additional sparging effect, which may be desirable in certain situations (e.g. when the liquid is only partially degassed while entering the tank).

The methods and systems of the present disclosure, as described above and shown in the drawings, provide for storage receptacles with superior properties including the ability to store organic compounds, such as stabilized fuel, so that gasses—such as oxygen, and other vapors in the ullage do not re-dissolve into fuel. This allows for heavy and costly de-gassing equipment to be removed from the aircraft, reducing weight and cost compared to traditional techniques where fuel is degassed on-board and directly put to use, e.g. no intermediate storage. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method for mitigating gas and vapor absorption into organic compounds, the method comprising:
degassing an organic compound to generate a degassed organic compound that includes an O₂ content less than or equal to 50% of a saturated value of the organic compound;
transferring the degassed organic compound while preventing contamination of the organic compound through gas absorption; and
storing the degassed organic compound in a storage receptacle to mitigate gas and vapor absorption.

2. A method as recited in claim 1, wherein degassing the organic compound includes degassing by using a membrane.

3. A method as recited in claim 1, further comprising supplying inert gas to the storage receptacle, wherein transferring the degassed organic compound includes pumping the degassed organic compound into the storage receptacle supplied with the inert gas.

4. A method as recited in claim 3, wherein supplying inert gas to the storage receptacle includes supplying the inert gas with an on-board inert gas generating system (IGGS).

5. A method as recited in claim 4, wherein the IGGS receives compressed air from a load compressor powered by at least one of an auxiliary power unit (APU) or ground power.

6. A method as recited in claim 3, wherein supplying inert gas to the storage receptacle includes supplying enough inert gas to generate an inert atmosphere with less than 1% O₂ by volume.

7. A method as recited in claim 1, further comprising continuing to supply the inert gas to the storage receptacle after filling to prevent contamination after filling.

8. A method as recited in claim 1, further comprising pre-purging the storage receptacle by supplying inert gas to the storage receptacle before transferring the degassed organic compound.

9. A method as recited in claim 1, wherein the storage receptacle is at least one of an off-board bladder tank, a hermetically sealed off-board fuel tank, a vented off-board fuel tank, an on-board bladder tank, a hermetically sealed on-board fuel tank, or a vented on-board fuel tank.

10. A method as recited in claim 1, wherein the storage receptacle is a tank, storage vessel, product package, container, or bladder for at least one of a comestible product, an essential oil, or an infused oil.

11. An organic compound storage and transfer system comprising:
an organic compound source, wherein an organic compound from the organic compound source includes an O₂ content less than or equal to 50% of a saturated value of the organic compound;
a storage receptacle in fluid communication with the organic compound source; and
an inert gas source in fluid communication with the storage receptacle to purge the storage receptacle of other gasses and vapors.

12. A system as recited in claim 11, wherein the inert gas source is an on-board inert gas generating system (IGGS).

13. A system as recited in claim 12, further comprising a load compressor in fluid communication with the IGGS to provide compressed air to the IGGS, wherein the load compressor is powered by at least one of an APU or ground power.

14. A system as recited in claim 11, wherein the storage receptacle is at least one of an off-board storage receptacle, an on-board storage receptacle, a vented storage receptacle, or a hermetically sealed storage receptacle.

15. A system as recited in claim 11, wherein the storage receptacle is a bladder.

16. A system as recited in claim 15, wherein the bladder comprises an elastomeric material.

17. A system as recited in claim 11, wherein the inert gas source comprises primarily N₂.

18. A system as recited in claim 11, wherein the inert gas source is a catalytic oxidation system.

19. A system as recited in claim 11, wherein the inert gas source is an electrochemical gas separation system.

20. A system as recited in claim 11, wherein the inert gas source is in fluid communication with an inlet at a bottom of the storage receptacle to provide an inert gas thereto.
